(19) United States
(12) Patent Application Publication
(10) Pub. No.: US 2010/0072376 A1
(43) Pub. Date: Mar. 25, 2010

(54) SPECTRAL FILTER FOR USE WITH LUTETIUM-BASED SCINTILLATORS

(75) Inventor: Cees RONDA, Aachen (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., Eindhoven (NL)

(21) Appl. No.: 12/557,738

(22) Filed: Sep. 11, 2009

Related U.S. Application Data
(60) Provisional application No. 61/098,823, filed on Sep. 22, 2008.

(51) Int. Cl. G01T 1/20

(52) U.S. Cl. 250/362; 250/368; 250/363.01

(57) ABSTRACT

A spectral filter used in conjunction with a lutetium-based scintillation material in a radiation detector is in imaging systems. The spectral filter operates to block at least a portion, but preferably substantially all, of an undesired infrared afterglow which results from ytterbium impurities in the lutetium-based scintillation material.

### CROSS REFERENCE TO RELATED APPLICATIONS

This application claims the benefit of U.S. provisional application Ser. No. 61/098,823 filed Sep. 22, 2008, which is incorporated herein by reference.

The present application relates generally to the imaging arts and more particularly to a spectral filter for use with a lutetium-based scintillation material. The application subject matter finds particular use with imaging systems which benefit from a high spatial resolution or a high signal to noise ratio. Examples of such imaging systems include time-of-flight PET systems and high signal to noise ratio SPECT and CT systems. However, the present application more generally applies to any imaging system incorporating a lutetium-based scintillation material.

Generally speaking, such imaging systems include a radiation source and a radiation detector. An imaged subject such as a human patient interacts with the radiation produced by the radiation source so that, when the radiation reaches the detector, the radiation exhibits properties which can be electronically processed to produce an image of the subject. In CT the radiation comprises x-rays, while in SPECT and PET the radiation comprises gamma rays. Other kinds of imaging systems may use different kinds of radiation.

The radiation detector in such imaging systems often uses a scintillation material, which operates to harness the energy of incoming radiation and convert it to a secondary photon signal. The secondary photon signal generated by the scintillation material can in turn be harnessed by a photodetector such as a photomultiplier, photodiode, or avalanche photodiode, and converted into an electronic signal for processing by electronic circuitry in order to produce an image of the subject. Many kinds of scintillation materials are known, some of which are lutetium-based scintillation materials. “Lutetium-based” scintillation materials include the chemical element lutetium. Representative examples of lutetium-based scintillators include cerium-doped lutetium orthosilicate (LSO), cerium-doped lutetium yttrium orthosilicate (LYSO), cerium-doped lutetium pyrosilicate (LPS), lutetium orthoaluminate (LuAP), terbium lutetium aluminum garnet (LuTAG), europium-doped or cerium-doped LuBO₃ coatings, and the like. Lutetium-based scintillators may be formed as a crystal, a ceramic, a composite, a coating, or have any other form suitable for a particular application.

The performance of a scintillating material depends on many properties of the material, including for example its stopping power, brightness, and afterglow. Regarding afterglow in particular, a scintillator's afterglow is the persistence of excited light beyond the main emission. Afterglow may result from defects in the scintillation material, or impurities, or have other causes. Generally speaking, it is desirable to reduce a scintillator's afterglow. That is, an afterglow which is shorter in time is preferred to an afterglow which is longer in time. Similarly, an afterglow having a narrower wavelength spectrum is preferred to an afterglow having a broader wavelength spectrum. A smaller afterglow is advantageous because it increases the number of scintillation events which may be detected in a given time period, and also increases the temporal resolution of the radiation detector.

As already mentioned, undesirable scintillator afterglow can result from impurities present in the scintillator material. Manufacturing a suitable scintillator for commercial use in a radiation detector is a complicated and expensive process. The process begins with gathering or synthesizing the requisite raw materials from nature. The raw materials are typically processed to remove impurities. After the raw materials are gathered and purified to the extent practicable, they are then combined to form a scintillator. Crystalline scintillators are often formed by melting the raw materials together in a molten pool of material, which is then crystallized. Ceramic scintillators are often formed by pressing techniques and high temperature heat treatments, however, without melting the scintillator material. A scintillator may also be a composite material, comprising a mixture of a scintillating powder dispersed within a host medium such as a resin, wherein the scintillating powder and the host medium have a similar index of refraction. Other manufacturing processes may be used.

One drawback of using lutetium-based scintillators is that they often contain ytterbium impurities. That is because lutetium and ytterbium have many similar chemical properties, so it is difficult to remove ytterbium impurities in a commercially or economically feasible manner. This difficulty can be acute, because natural sources of lutetium salts used to manufacture lutetium-based scintillators are often found intermixed with ytterbium in nature. The inventors believe, without being bound by their theory herein, that this ytterbium causes an undesirable afterglow in the infrared region centered at about 980 nm.

According to one aspect of the present invention, a spectral filter is provided to reduce or substantially eliminate an unwanted portion of light produced by a lutetium-based scintillator. Such a filter may be used to reduce the effects of afterglow from the scintillator, such as the ytterbium-caused afterglow which may be present in lutetium-based scintillating materials.

The invention may take form in various chemical compositions, various components and arrangements of components, and in various process operations and arrangements of process operations. The drawings are only for the purpose of illustrating preferred embodiments and are not to be construed as limiting the invention.

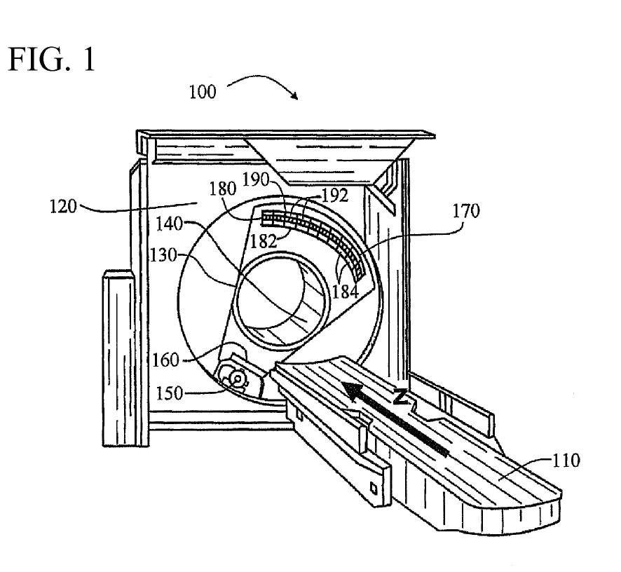

FIG. 1 is an exemplary CT imaging system, with a portion of the stationary gantry cut away to reveal the rotating gantry, x-ray source and radiation detector; and

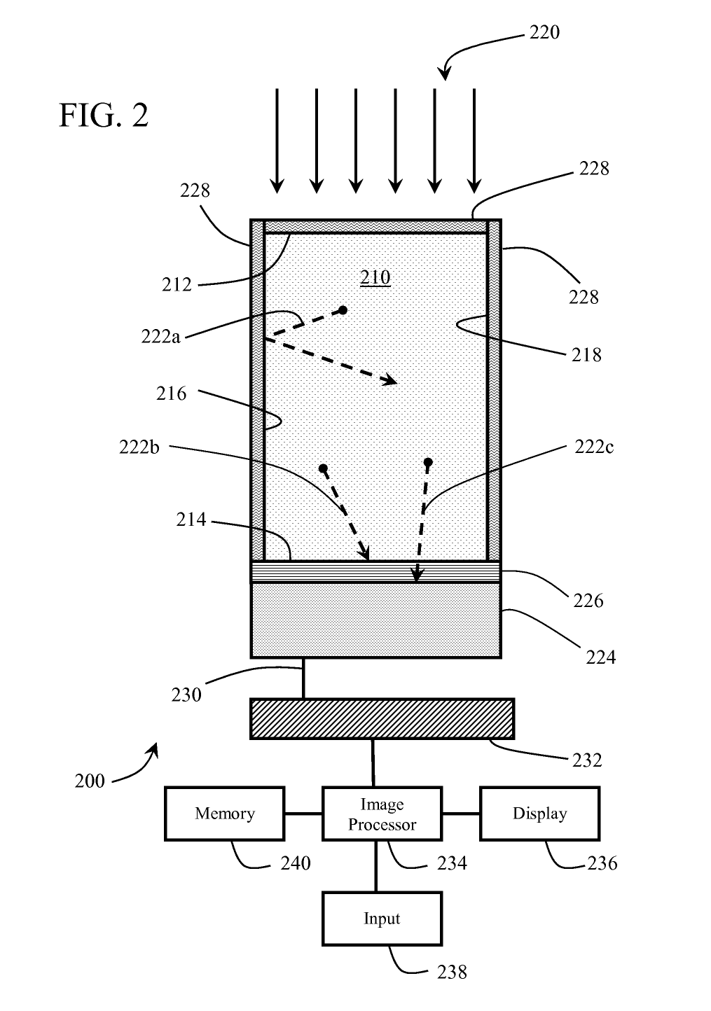

FIG. 2 is a cross-section view of a radiation detector incorporating a lutetium-based scintillator and a spectral filter.

The medical imaging system and apparatus of the present application is generally any medical imaging system, for example, a CT, SPECT or PET imaging system. More specifically, with reference to FIG. 1, in an exemplary embodiment, the medical imaging system 100 is a CT imaging system. The CT imaging system 100 includes a subject support 110, such as a table or couch, which supports and positions a subject being examined and/or imaged, such as a patient. The CT imaging system 100 includes a stationary gantry 120 with a rotating gantry 130 mounted inside. A scanning tube 140 extends through the stationary gantry 120. The scanning tube 140 defines an examination region. The subject support 110 is linearly movable along a Z-axis relative to the scanning tube 140, thus allowing the subject support 110 and the imaged subject when placed thereon to be moved within and removed from the scanning tube 140.

The rotating gantry 130 is adapted to rotate around the scanning tube 140 (i.e., around the Z-axis) and the imaged subject when located therein. One or more x-ray sources 150 with collimator(s) 160 are mounted on the rotating gantry 130 to produce an x-ray beam directed through the scanning tube 140 and the imaged subject when located therein.

One or more radiation detector units 170 are also mounted on the rotating gantry 130. Typically, the x-ray source(s) 150 and the radiation detector unit(s) 170 are mounted on opposite sides of the rotating gantry 130 from one another and the rotating gantry 130 is rotated to obtain an angular range of projection views of the imaged subject. The radiation detector unit(s) 170 include a scintillating material 180. The scintillating material 180 may be, for example, a lutetium-based scintillating material. In some embodiments, the scintillating material 180 is made up of an array of individual crystals that are assembled together or cut from a common scintillator plate by photoetching or some other technique.

The CT imaging system 100 may include a grid 182, such as an anti-scatter grid, which is arranged on a radiation receiving face of the scintillating material 180. An array 190 of photodetectors 192, such as photodiodes or photomultipliers, is provided on the opposite side of the scintillating material 180 from the grid 182. Each of the photodetectors 192 is independently responsive to the scintillation events that occur in the corresponding section 184 of the scintillating material 180.

A computer (not shown) controls the operation of the CT imaging system 100, including the operation of the subject support 110 and rotating gantry 130. The data acquired by the detector unit(s) 170 is reconstructed to form a CT image that can optionally be displayed on the computer, using conventional methods.

Although not shown in the Figures, a PET or SPECT imaging system is similar to the CT imaging system 100 of FIG. 1. Like the CT imaging system 100, a PET or SPECT system typically has a linearly translating table which can extend into a scanning tube of a gantry. However, the gantry of a PET or SPECT system typically houses a stationary ring of radiation detectors disposed around the scanning tube. In a PET or SPECT imaging system, the radiation source is typically a radiopharmaceutical or other gamma ray source ingested by or injected into the subject to be imaged. The radiation detectors disposed in a ring around the scanning tube operate to harness the gamma rays produced by the source, and generate a corresponding electrical signal. The electrical signals generated by the various radiation detectors can then be electronically processed to produce a PET or SPECT image of the subject.

FIG. 2 illustrates an exemplary embodiment of a radiation detector unit 200. The unit 200 can be used in CT, PET or SPECT systems, or other similar imaging systems. The radiation detector unit 200 includes a lutetium-based scintillator 210 which, from the perspective of the view in FIG. 2, has a top face 212, a bottom face 214, and four side faces. Only two side faces 216 and 218 are shown in the cross-sectional view of FIG. 2. The relative terms “top”, “bottom” and “side” have meaning only from the perspective of FIG. 2. They do not have any functional significance in the operation of the unit 200. Thus, in particular applications, the unit 200 may be placed in an imaging system such that the face 212 is actually a bottom face.

The Figures and this written description describe exemplary embodiments of x-ray detector units. The Figures are schematic in nature, meant principally for illustration and not as an exact depiction to scale of the elements shown. Therefore, the dimensions of a given element in relation to the dimensions of other elements as shown in the Figures do not necessarily reflect such relative dimensions as one would find in an actual x-ray detector unit. For example, in an actual x-ray detector unit, the reflector material 228 would be much thinner in relation to the size of the scintillator 210 than illustrated in the FIG. 2.

The radiation detector unit 200 functions to harness incoming radiation 220 impinging upon the top face 212 and produce an electric signal which is representative of the radiation 220. The first step in this process is performed by the lutetium-based scintillator 210, which acts as a transducer by absorbing the energy of the incoming radiation 220 and converting that energy to secondary photons 222 such as 222a, 222b and 222c in FIG. 2. The secondary photons 222 produced by the scintillator 210 are thus representative of the radiation 220.

The radiation detector module 200 includes a photodetector 224 such as a photomultiplier, a photodiode, or an avalanche photodiode. The photodetector 224 is optically coupled to the bottom face 214 of the lutetium-based scintillator 210, with a filter 226 disposed in the optical path between the lutetium-based scintillator 210 and the photodetector 224. The photodetector 224 absorbs the energy of secondary photons 222 produced by the lutetium-based scintillator 210 and converts that energy to an electrical signal. The electrical signals produced by the photodetector 224 are representative of the secondary photons 222 impinging upon the photodetector 224, and thus also the incoming radiation 220.

The lutetium-based scintillator 210 is covered with a reflector material 228 on each portion of its exterior other than the region(s) where the photodetector 224 is optically coupled to the lutetium-based scintillator 210. The reflector material 228 reflects optical photons such as the representative secondary photon 222a, but permits the incoming radiation 220 to pass through unaffected. Thus, the secondary photons 222 must exit the lutetium-based scintillator 210 (if they exit at all) through the filter 226 and the photodetector 224 (except some small loss). Some secondary photons 222 will be self-absorbed by the lutetium-based scintillator 210 before they can reach the filter 226, and some may escape through or past the reflector material 228.

The photodetector 224 has an electrical lead 230 connecting the photodetector 224 to a circuit board 232. The circuit board 232 receives electrical signals from the photodetector 224 through that lead 230 and passes them on to signal processing hardware and further on to an image processor 234. The image processor 234 processes electrical signals received from several different radiation detector modules 200 in the imaging system to form an image of a subject according to a mathematical algorithm or algorithms. The image can be displayed on an associated display 236. A user input 238 may be provided for a user to control the image processor 234. The image processor 234 may store related imaging data and other data in a memory 240.

The aforementioned functions and other functions described below can be performed as software logic. “Logic,” as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic such as an application specific integrated circuit (ASIC), or other programmed logic device. Logic may also be fully embodied as software. “Software,” as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory such as memory 240, part of an operating system or other type of executable instructions. It will be appreciated by one of ordinary skill in the art that the form of software is dependent on, for example, requirements of a desired application, the environment it runs on, and/or the desires of a designer/programmer or the like.

The systems and methods described herein can be implemented on a variety of platforms including, for example, networked control systems and stand-alone control systems. Additionally, the logic shown and described herein preferably resides in or on a computer readable medium such as the memory 240. Examples of different computer readable media include Flash Memory, Read-Only Memory (ROM), Random-Access Memory (RAM), programmable read-only memory (PROM), electrically programmable read-only memory (EPROM), electrically erasable programmable read-only memory (EEPROM), magnetic disk or tape, optically readable mediums including CD-ROM and DVD-ROM, and others. Still further, the processes and logic described herein can be merged into one large process flow or divided into many sub-process flows. The order in which the process flows herein have been described is not critical and can be rearranged while still accomplishing the same results. Indeed, the process flows described herein may be rearranged, consolidated, and/or re-organized in their implementation as warranted or desired.

As already discussed, lutetium-based scintillation materials 210 can be subject to ytterbium impurities. The inventors believe, without being bound by their theory herein, that the ytterbium impurities can cause an undesirable afterglow. In particular, the desired response of such scintillators to incoming radiation is production of secondary photons 222 in the ultraviolet region, having wavelengths above about 175 or about 200 nm, and below about 400 or about 380 nm. In some cases, for example when the lutetium-based scintillator is activated with Neodymium (Nd³⁺), the desired spectrum may extend down to about 175 nm. In other cases the desired spectrum may extend down only to about 200 nm. At the upper end, in many cases the desired spectrum may extend up to about 400 nm. However, when Ytterbium is present in low concentrations, it may cause an afterglow at for example about 390 nm. In such cases, it may be advantageous to cut off the desired wavelength range at about 380 nm to avoid that afterglow.

Also it is believed, without being bound by theory herein, that the ytterbium impurities can cause an undesirable afterglow in the infrared region with wavelengths between about 700 and 1400 nm, and centered at about 980 nm. Many photodetectors, such as some avalanche photodiodes, are sensitive to light in that infrared region. The ytterbium-caused afterglow in the infrared region has a relatively long decay time on the order of microseconds to milliseconds, relative to the desired scintillator response in the ultraviolet region which has a decay time on the order of only nanoseconds. In this context, a scintillator's decay time is the time after which the intensity of the light pulse falls to 1/e (approximately 0.318) of its initial and maximum value. Thus, if there are enough ytterbium impurities present in the lutetium-based scintillator, the resulting infrared afterglow can negatively influence the performance of the scintillator. For example, the infrared afterglow can reduce the coincidence-timing precision as well as the timing resolution in time-of-flight PET systems, which negatively impacts the spatial resolution. In addition, the infrared afterglow can reduce the trigger precision in SPECT systems, which in turn reduces the signal-to-noise ratio and thus requires an increased amount of radioactive material to be administered. The infrared afterglow further reduces the possible gantry rotation frequency in CT, which increases the amount of time required to perform an imaging scan.

However, use of a spectral filter 226 can substantially eliminate the undesirable ytterbium-caused infrared afterglow and thus improve the performance of the radiation detector unit 200. As shown for example in FIG. 2, the spectral filter 226 may be placed in the optical path between the scintillator material 210 and the photodetector 224. The spectral filter 226 operates to remove the undesirable secondary photons 222b in the infrared region, while transmitting the desirable secondary photons 222c in the ultraviolet region.

The spectral filter 226 may take many forms. For example, the spectral filter 226 may be an absorbing filter which absorbs the undesired infrared afterglow light, but transmits the desired ultraviolet light. As another example, the spectral filter 226 may be a reflecting filter which reflects the undesired afterglow light, but transmits the desired ultraviolet light. It may be a short wavelength pass (SWP) interference filter produced by deposition of transparent layers with alternating low and high refractive indexes. Due to the large separation between the desired (ultraviolet) wavelengths and the undesired (infrared) wavelengths, such interference filters can be effective with only about ten layers, making them cost effective. Thus, in general, the optical quality of whatever filter is chosen need not be exceptionally high. They may, for example, substantially block all light having a wavelength greater than about 950 nm. Indeed, many types of filters are known which would be suitable for application here, such as glass filters, interference filters, diffraction grating filters, prisms, and the like.

The spectral filter 226 may be inserted in the optical path between the scintillator material 210 and the photodetector 224 in a variety of manners, such as the following representative examples. The filter 226 may be physically attached to either the scintillator 210 or the photodetector 224, or both. Further, conventional photodetectors 224 often have a layer of optical cement disposed between the scintillator material 210 and the photodetector 224, in order to firmly hold the two components together and transmit light from the scintillator 210 to the photodetector 224. The spectral filter 226 may be placed within such a layer of optical cement. As another alternative, conventional systems also often have an optical coating on the photodetector 224 to enhance the sensitivity spectrum of the photodetector 224. The spectral filter 226 may be formed from additional coating(s) placed on the photodetector 224.

As yet another alternative, a composite scintillator material may be used, comprising a mixture of a scintillating powder dispersed within a host medium such as a resin, wherein the scintillating powder and the host medium have a similar index of refraction. In such situations, a small amount of a soluable light absorber or dye may be incorporated within the host medium. The light absorber acts as a filter by absorbing the infrared light and not absorbing the ultraviolet light. Preferably, the light absorber is sufficiently radiation hard.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof. The invention may take form in various chemical compositions, components and arrangements, combinations and sub-combinations of the elements of the disclosed embodiments.

Having thus described the preferred embodiments, the invention is now claimed to be:

1. A radiation detector comprising:
a scintillator comprising a lutetium-based scintillation material;
a photodetector optically coupled to the scintillator; and
a spectral filter disposed in an optical path between the scintillator and the photodetector and adapted to block at least a portion of a light emitted from the scintillator.

2. The radiation detector of claim 1, wherein the spectral filter blocks substantially all light having a wavelength greater than about 950 nm.

3. The radiation detector of claim 1, wherein the spectral filter blocks substantially all light having a wavelength greater than about 400 nm.

4. The radiation detector of claim 1, wherein the spectral filter is a short wavelength pass interference filter.

5. The radiation detector of claim 1, wherein the spectral filter blocks substantially all light having a wavelength less than about 175 nm.

6. The radiation detector of claim 1 wherein the spectral filter is a long wavelength pass interference filter.

7. The radiation detector of claim 1, wherein the spectral filter is physically attached to the photodetector.

8. The radiation detector of claim 1, wherein the spectral filter is physically attached to the lutetium-based scintillation material.

9. The radiation detector of claim 1, wherein the radiation detector detects x-rays for use in a CT imaging system.

10. The radiation detector of claim 1, wherein the radiation detector detects gamma rays for use in a PET or SPECT imaging system.

11. A method for detecting radiation comprising the steps of:
receiving radiation with a lutetium-based scintillation material, wherein the lutetium-based scintillation material emits secondary photons in response to receiving the radiation;
filtering the secondary photons emitted by the lutetium-based scintillation material to block at least a portion of a light emitted from the lutetium-based scintillation material and transmit a filtered light; and
detecting the filtered light with a photodetector.

12. The method of claim 11, wherein the spectral filter blocks substantially all secondary photons having a wavelength greater than about 950 nm.

13. The method of claim 11, wherein the spectral filter blocks substantially all secondary photons having a wavelength greater than about 400 nm.

14. The method of claim 11, wherein the spectral filter blocks substantially all secondary photons having a wavelength less than about 175 nm.

15. The method of claim 11, wherein the spectral filter is a short wavelength pass interference filter.

16. The method of claim 11, wherein the spectral filter is a long wavelength pass interference filter.

17. An imaging device comprising:
at least one radiation source;
at least one radiation detector comprising
a lutetium-based scintillation material,
a photodetector optically coupled to the lutetium-based scintillation material,
a spectral filter disposed in an optical path between the lutetium-based scintillation material and the photodetector and adapted to block at least a portion of an infrared light emitted from the lutetium-based scintillation material, and
a circuit board to receive an electrical signal from the photodetector and transmit the electrical signal; and
an image processor to process the electrical signal from the circuit board to form an image of a subject according to one or more algorithms.

18. The imaging device of claim 17, wherein the spectral filter blocks substantially all light having a wavelength greater than about 950 nm.

19. The imaging device of claim 17, wherein the spectral filter is physically attached to the photodetector.

20. The imaging device of claim 17, wherein the spectral filter is physically attached to the lutetium-based scintillation material.
